(19) United States
(12) Patent Application Publication
(10) Pub. No.: US 2021/0350401 A1
(43) Pub. Date: Nov. 11, 2021

(54) SYSTEMS AND METHODS FOR EXPERIMENTATION OF E-COMMERCE PRICING DISTRIBUTION BASED ON TIME-INTERLEAVING

(71) Applicant: COUPANG CORP., Seoul (KR)

(72) Inventors: JIE WENG, Los Altos, CA (US); Nuri Mehmet Gokhan, San Mateo, CA (US); Qian Weng, Palo Alto, CA (US)

(73) Assignee: Coupang Corp.

(21) Appl. No.: 16/871,126

(22) Filed: May 11, 2020

(51) Int. Cl. G06Q 30/02; G06F 16/958

(52) U.S. Cl. CPC G06Q 30/0223; G06Q 30/0201; G06F 16/958; G06Q 30/0224; G06Q 30/0206

(57) ABSTRACT

A system for experimentation of e-commerce pricing distribution based on time-interleaving includes one or more processors configured to identifying a first set of items from a plurality of items based on one or more item pricing policies. Scheduling the first set of items to be published on a website during a first time slot from a plurality of time slots by applying a scheduling algorithm. Identifying a first subset of substitutable items and a second subset of substitutable items from the first set of items based on one or more item substitution rules. Assigning the first subset of substitutable items with a first pricing policy and the second subset of substitutable items with a second pricing policy. Publishing the first subset of substitutable items and the second subset of substitutable items. Determining pricing distribution data based on monitoring customer interaction.

### TECHNICAL FIELD

Embodiments of the present disclosure relate to systems and methods for experimentation of e-commerce pricing distribution. More particularly, embodiments of the present disclosure relate to systems and methods for experimentation of e-commerce pricing distribution based on time-interleaving.

### BACKGROUND

Users (e.g., online customers) often use websites or mobile applications to order items (e.g. food, groceries, clothing, toys, etc.). By way of example, users order items via e-commerce websites. In current marketplace e-commerce websites compete with each other to provide items with competitive pricing. E-commerce websites constantly change prices of their items based on various factors, such as, public holidays, seasonal changes, price match a competitor, etc. In a situation where the e-commerce websites would like to change prices of items, the operators of those websites would like to understand if the price change is favorable for the e-commerce website and/or if that price change receives a positive customer response before making the price change in a real world environment.

Current solutions that are utilized by e-commerce websites would perform testing of new price changes of items by selecting a group of customers and targeting these customers with new price changes. Such solutions involve significant technical disadvantages. For example, testing price changes on targeted customers, results in collecting data that is not beneficial to determine accurate results of testing and thus such testing uses network resources inefficiently. Repeated testing may be required, which again results in inefficient use of network resources. By way of example, current solutions do not consider special discounts being utilized by targeted customers as part of testing. Utilization of special discounts include coupon utilization and/or credit card account points utilization during purchase of items. Current solutions require extensive network resources for collecting of customer discount data across databases as well as analyzing of the utilization of the customer discount data by processing servers to take into consideration such special discounts. As another example, in current solutions, testing targeted customers may be performed during a first week and a second week. However, such systems do not account for factors such as seasonal changes during a first week and a second week. Further, the resulting number of samples collected are limited.

Additionally, presenting different prices to different customers for the same item may result in a loss of customer trust. Further, current solutions also do not take into consideration various factors that could affect a customer's response in the real-world environment. Accordingly, current solutions are inefficient and result in negative customer experience, thus there is a need to provide an optimized method of testing of price changes of items on e-commerce websites.

### SUMMARY

In accordance with embodiments of the present disclosure, there is provided a system for experimentation of e-commerce pricing distribution based on time-interleaving, the system comprising: a memory storing instructions; and at least one processor configured to execute the instructions to: identify a first set of items from a plurality of items based on one or more item pricing policies; schedule the first set of items to be published on a website during a first time slot from a plurality of time slots, by applying a scheduling algorithm, publishing the first set of items during the first time slot, further comprising: identify a first subset of substitutable items and a second subset of substitutable items from the first set of items based on one or more item substitution rules; assign the first subset of substitutable items with a first pricing policy and the second subset of substitutable items with a second pricing policy; publish the first subset of substitutable items assigned with the first pricing policy over the first time slot on the website and publishing the second subset of substitutable items assigned with the second pricing policy over the first time slot on the website; and determine pricing distribution data based on monitoring customer interaction with the published first subset of customer substitutable items and the published second subset of customer substitutable items.

In accordance with embodiments of the present disclosure, there is also provided a computer implemented method for experimentation of e-commerce pricing distribution based on time-interleaving, the method comprising: identifying a first set of items from a plurality of items based on one or more item pricing policies; scheduling the first set of items to be published on a website during a first time slot from a plurality of time slots, by applying a scheduling algorithm, publishing the first set of items during the first time slot, further comprising: identifying a first subset of substitutable items and a second subset of substitutable items from the first set of items based on one or more item substitution rules; assigning the first subset of substitutable items with a first pricing policy and the second subset of substitutable items with a second pricing policy; publishing the first subset of substitutable items assigned with the first pricing policy over the first time slot on the website and publishing the second subset of substitutable items assigned with the second pricing policy over the first time slot on the website; and determining pricing distribution data based on monitoring customer interaction with the published first subset of customer substitutable items and the published second subset of customer substitutable items.

In accordance with embodiments of the present disclosure, there is provided a system for experimentation of e-commerce pricing distribution based on time-interleaving, the system comprising: a memory storing instructions; and at least one processor configured to execute the instructions to: identifying a first set of items from a plurality of items based on one or more item pricing policies; scheduling the first set of items to be published on a website during a first time slot from a plurality of time slots, by applying a scheduling algorithm, publishing the first set of items during the first time slot, further comprising: identifying a first subset of substitutable items and a second subset of substitutable items from the first set of items based on one or more item substitution rules; assigning the first subset of substitutable items with a first pricing policy and the second subset of substitutable items with a second pricing policy; publishing the first subset of substitutable items assigned with the first pricing policy over the first time slot on the website and publishing the second subset of substitutable items assigned with the second pricing policy over the first time slot on the website; and determining pricing distribution data based on monitoring customer interaction with the published first subset of customer substitutable items and the published second subset of customer substitutable items.

### BRIEF DESCRIPTION OF DRAWINGS

The accompanying drawings, which are incorporated in and constitute a part of his specification, illustrate disclosed embodiments and, together with the description, serve to explain the disclosed embodiments. In the drawings:

FIG. 1 is a block diagram of an exemplary system, consistent with disclosed embodiments;

FIG. 2 is a block diagram of an exemplary server system, consistent with disclosed embodiments;

FIG. 3 is a block diagram of an exemplary user device, consistent with disclosed embodiments;

FIGS. 4A-4B contains a detailed flowchart of an exemplary process for experimentation of e-commerce pricing distribution based on time-interleaving, consistent with disclosed embodiments;

FIG. 5A contains a pricing distribution table for the exemplary process for experimentation of e-commerce pricing distribution based on time-interleaving, consistent with disclosed embodiments;

FIG. 5B depicts a sample Search Result Page (SRP) that includes one or more search results satisfying a search request along with interactive user interface elements, consistent with the disclosed embodiments;

FIG. 5C depicts a sample Single Display Page (SDP) that depicts an item and information about the item along with interactive user interface elements, consistent with the disclosed embodiments;

FIG. 5D depicts a sample Cart page that includes items in a virtual shopping cart along with interactive user interface elements, consistent with the disclosed embodiments; and

FIG. 5E depicts a sample Order page that includes items from the virtual shopping cart along with information regarding purchase and shipping, along with interactive user interface elements, consistent with the disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

While the following description is directed to e-commerce price experimentation based on time-interleaving, these embodiments are made by example only. It should be appreciated that the present disclosure is not limited to the specific disclosed embodiments and details, which are exemplary only. It is further understood that one possessing ordinary skill in the art, in light of known systems and methods, would appreciate the use of the embodiments of the present disclosure for their intended purposes and benefits in any number of alternative embodiments, depending on specific design and other needs.

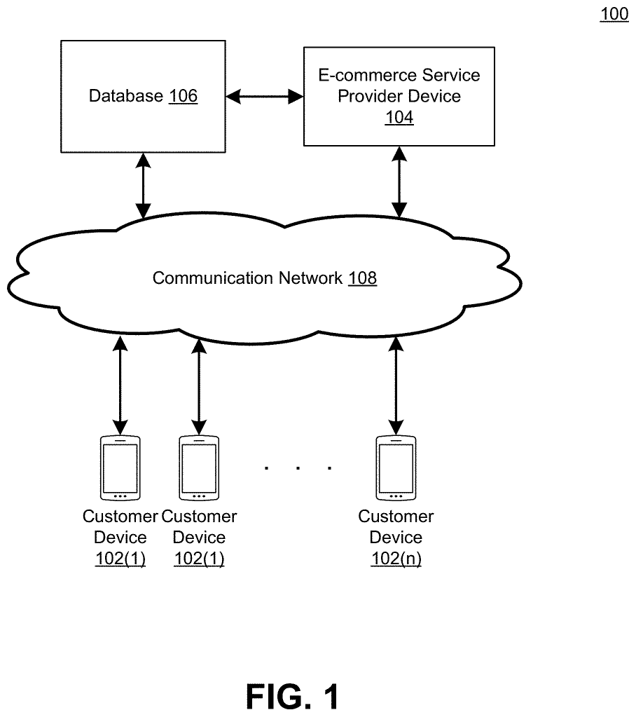

FIG. 1 is a block diagram of an exemplary system 100, for performing one or more operations consistent with disclosed embodiments. In some embodiments, system 100 includes one or more customer devices 102(1), . . . 102(n), an e-commerce service provider device 104, a database 106 and a communication network 108. The system 100 may also include a plurality of e-commerce service provider devices 104 (not shown in drawings), and a plurality of databases 106 (not shown in drawings) communicating with each other directly and further communicating with the customer devices 102(1)-102(n), via the communication network 108. The components and arrangement of the components included in system 100 may vary. Thus, system 100 may include other components that perform or assist in the performance of one or more operations consistent with the disclosed embodiments.

As more fully described below, customer devices 102(1)-102(n), e-commerce service provider device 104, and database 106 may include one or more computing devices (e.g., computer(s), server(s), etc.), memory storing data and/or software instructions (e.g., database(s), memory devices, etc.), and other known computing components. In some embodiments, the one or more computing devices may be configured to execute software instructions stored in the memory to perform one or more operations consistent with the disclosed embodiments. Aspects of customer device(s) 102(1)-102(n), e-commerce service provider device 104, and database 106 may be configured to communicate with one or more other components of system 100 via communication network 108, for example. In certain aspects, customers operate customer devices 102(1)-102(n), interact with one or more components of system 100 by sending and receiving communications, initiating operations, and/or providing input for one or more operations consistent with the disclosed embodiments.

E-commerce service provider device 104 may be associated with an online ordering entity that receives, processes, manages, or otherwise offers ordering services for items. Online ordering entity may be an e-commerce website used to buy items and get them delivered by customers associated with customer devices 102(1)-102(n). For example, the items that may be ordered via the online ordering entity may include prepared food, groceries, electronics, furniture, books, computers, and/or clothes, although any other type of items may also be ordered. For example, the e-commerce service provider device 104 may receive order requests from customers using customer devices 102(1)-102(n) and process the received order requests to ship items ordered in the order request to the customers associated with the order request.

Database 106 of system 100 may be communicatively coupled to e-commerce service provider device 104 directly or via communication network 108. Further, the database 106 of system 100 may be communicatively coupled to customer devices 102(1)-102(n), and e-commerce service provider device 104 via the communication network 108. Database 106 may include one or more memory devices that store information and are accessed and/or managed by one or more components of system 100. By way of example, database 106 may include Oracle™ databases, Sybase™ databases, or other relational databases or nonrelational databases, such as Hadoop sequence files, HBase, or Cassandra. Database 106 may include computing components (e.g., database management system, database server, etc.) configured to receive and process requests for data stored in memory devices of database 106 and to provide data from database 106. In another embodiment, e-commerce service provider device 104 may store database 106 locally within it. By way of example, when server device 200 is implemented as e-commerce service provider device 104, database 104 may be stored in memory 202.

Database 106 is configured to store, among another things, customer profile information for customers associated with the customer devices 102(1)-102(n), and a list of items available in an inventory. The list of items available in the inventory may include the items that may be ordered via the online ordering entity, which may include, prepared food, groceries, electronics, furniture, books, computers, and/or clothes, although any other type of items may also be included in the inventory. Further, customer profile information in database 106 may include customer name, customer home address, customer photos, and/or customer phone number, although any other type of information associated with the merchant can also be included.

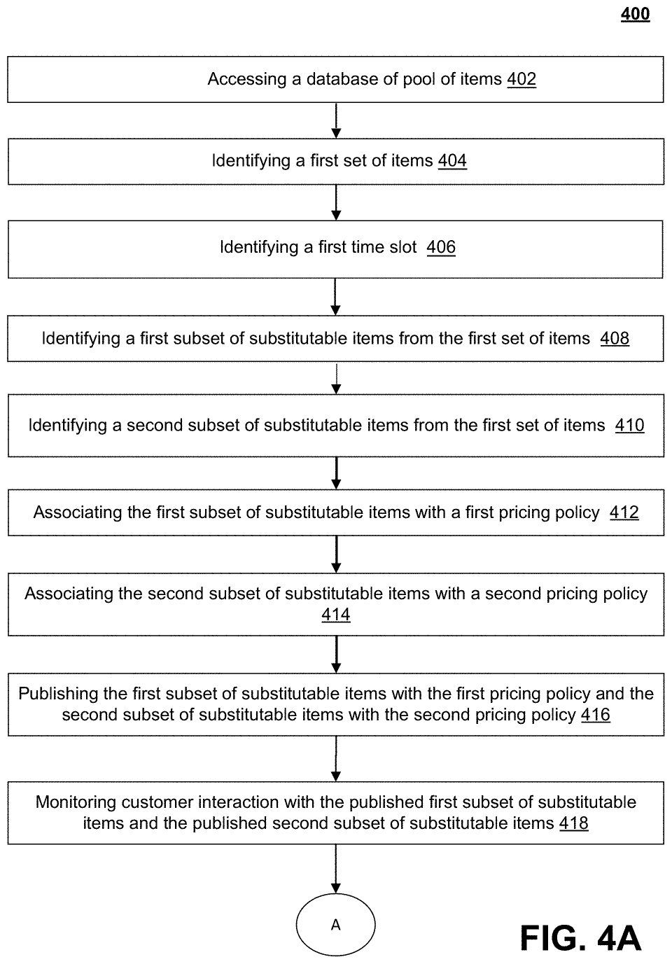

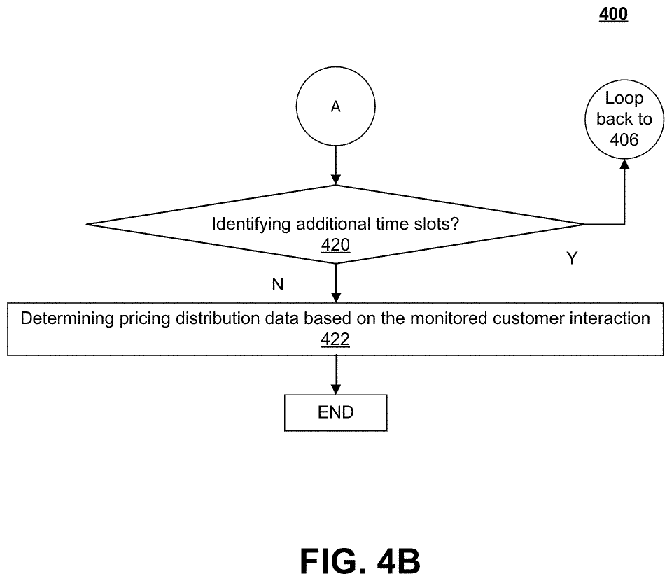

In one aspect, e-commerce service provider device 104 may include one or more computing devices, configured to perform one or more operations consistent with disclosed embodiments as described more fully below in relation to FIGS. 4A-4B. In one aspect, e-commerce service provider device 104 may include one or more servers or server systems. E-commerce service provider device 104 may include one or more processors configured to execute software instructions stored in a memory or other storage device. The one or more processors may be configured to execute the stored software instructions to perform network communication, online order-based processes of e-commerce pricing distribution based on time-interleaving. The one or more computing devices of e-commerce service provider device 104 may be configured to store customer profile information and a list of items available in an inventory. The one or more computing devices of e-commerce service provider device 104 may also be configured to communicate with other components of system 100 to receive and process order requests. In some embodiments, e-commerce service provider device 104 may provide one or more mobile applications, web-sites, or online portals that are accessible by customer devices 102(1)-102(n) over communication network 108. The disclosed embodiments are not limited to any particular configuration of e-commerce service provider device 104.

Communication network 108 may comprise any type of computer networking arrangement configured to provide communications or exchange data, or both, between components of system 100. For example, communication network 108 may include any type of network (including infrastructure) that provides communications, exchanges information, and/or facilitates the exchange of information, such as the Internet, a private data network, a virtual private network using a public network, a LAN or WAN network, a Wi-Fi™ network, and/or other suitable connections that may enable information exchange among various components of system 100. Communication network 108 may also include a public switched telephone network (“PSTN”) and/or a wireless cellular network. Communication network 108 may be a secured network or unsecured network. In some embodiments, one or more components of system 100 may communicate directly through a dedicated communication link(s).

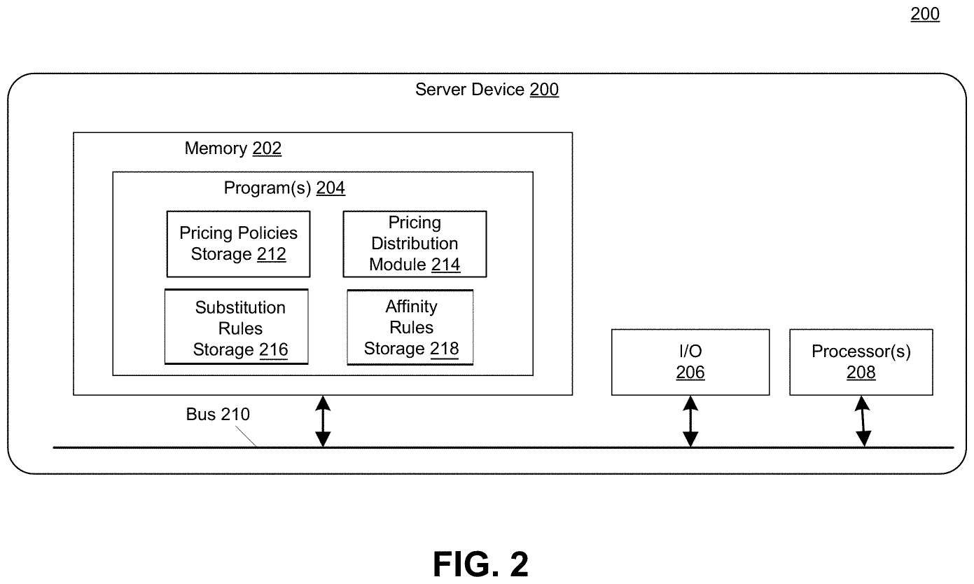

Customer devices 102(1)-102(n) may be one or more computing devices configured to perform one or more operations consistent with the disclosed embodiments, as described more fully below in relation to FIG. 2. Customer devices 102(1)-102(n) may execute browser or related mobile display software that displays an e-commerce website for placing orders for delivery of items, receiving orders and delivering items that are ordered, on a display included in, or connected to, customer devices 102(1)-102(n). Customer devices 102(1)-102(n) may also store and execute other mobile applications that allow customers to interact with a website interface provided by the e-commerce service provider device 104.

It is to be understood that the configuration of the functional blocks of system 100 has been defined herein for convenience of description. The components and arrangement of the components included in system 100 may vary. For example, in some embodiments, system 100 may include other components that perform or assist in the performance of one or more processes consistent with disclosed methods. System 100 includes a number of components generally described as computing devices. Each of the computing devices may include any number of computing components particularly configured as a special purpose computing device to perform the functionality disclosed herein. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

FIG. 2 shows an exemplary server device 200 consistent with the disclosed embodiments. Variations of exemplary server device 200 may constitute one or more components of e-commerce service provider device 104. In one embodiment, server device 200 includes one or more memories 202, one or more I/O devices 206, and one or more processors 208 communicating via a bus 210. In some embodiments, server device 200 may be a part of e-commerce service provider device 104. In some embodiments, server device 200 may take the form of a specially programmed server or computing system used by e-commerce service provider device 104 to perform complete functions of e-commerce service provider device 104. In some embodiments, server device 200 may be configured as an apparatus, embedded system, dedicated circuit, or the like based on the storage, execution, and/or implementation of software instructions that perform one or more operations consistent with the disclosed embodiments.

Memory 202 may include one or more storage devices configured to store instructions used by processor 208 to perform functions related to disclosed embodiments. For example, memory 202 may be configured with one or more software instructions, such as program(s) 204 that may perform one or more operations when executed by processor 208. The disclosed embodiments are not limited to separate programs or computers configured to perform dedicated tasks. For example, memory 202 may include a single program 204 that performs the functions of server device 200, or program 204 may comprise multiple programs. In certain embodiments, memory 202 may store sets of instructions or programs 204 for performing functions of e-commerce service provider device 104. These sets of instructions may be executed by processor 208 to perform communication and/or processes consistent with disclosed embodiments.

In certain embodiments, when server device 200 constitutes one or more of the components of e-commerce service provider device 104, memory 202 includes programs 204. Programs 204 may include pricing policies storage 212, pricing distribution module 214, and substitution rules storage 216 as described in detail below.

In other embodiments, each of the pricing policies storage 212, pricing distribution module 214, and substitution rules storage 216 may be implemented as separate and individual servers communicating with each other, and with database 106, and customer devices 102(1)-102(n), over communication network 108.

Pricing policies storage 212 may store a plurality of pricing policies. The plurality of pricing policies may include, for example, applying a 50% discount on the listed item price, providing free delivery by waiving shipping fees on items, identifying items that can be sold at a 10% discount on the listed item price while maintaining a profit margin of 20%, identifying items that can be shipped to customers with no shipping fees while maintaining a profit margin of 20%, identifying items that can be shipped to customers at a 50% discount on shipping fees maintaining a profit margin of 20%, providing coupons to customers upon purchasing an item, or providing cashback to customers upon purchasing an item, although any other type of item pricing related policies may also be included.

Pricing distribution module 214, is programmed to applying a scheduling algorithm stored in memory 202. Scheduling algorithm may include a random scheduling algorithm, although any other type of scheduling algorithm may also be included. Random scheduling algorithm may be an algorithm with pre-defined instructions stored in memory 202. Random scheduling algorithm may be programmed to perform a random selection of time slots from plurality of time slots at a time, in such an order that all of the time slots during a time period are utilized for scheduling of items in a manner such that none of time slots are utilized more than once during the time period. Such time periods may include 6 hours, 12 hours, a day, a week, or a month, although any other time period may also be included. In another example, random scheduling algorithm may be programmed to perform a random selection of time slots from plurality of time slots at a time, in such an order that all of the time slots during a time period are utilized for scheduling of items in a manner such that time slots are utilized twice during the time period, although any other order or combinations of selection of time slots from plurality of time slots may be included.

Substitution rules storage 216 stores substitution rules. Substitution rules may include, by way of example, those items that are identified to be the same category but from different brands, those items that are identified to be in the same category but have opposite sales patterns based on previous sales history data (further explained in detail below), although any other types of items that are can be substituted amongst each other may be included.

Affinity rules storage 218 stores affinity rules. Affinity rules may include, by way of example, associating a pricing policy to only one item from a set of items that have been identified to being purchased together or at the same time by customers, during a time slot. By way of example, a shaving razor item is identified as being purchased along with shaving gel by customers. In this situation, affinity rules may cause the price of a shaving razor or a shaving gel (not both) to be adjusted based on a pricing policy during a time slot.

Input/output (I/O) 206 may include various input/output devices, such as a keyboard, a mouse-type device, a gesture sensor, an action sensor, a physical button, switch, microphone, touchscreen panel, stylus, etc., that may be manipulated by customer devices 102(1)-102(n). I/O devices 206 may also include an audio output device. Exemplary communication modules of I/O devices 206 may include, for example, a short-range or near field wireless communication modem, a Wi-Fi™ communication modem, or a cellular communication modem. I/O devices 206 may include a transceiver or transmitter configured to communicate using one or more wireless technologies/protocols that may include, without limitation, cellular (e.g., 3G, 4G, etc.) technology, Wi-Fi™ hotspot technology, RFID, near-field communication (NFC) or BLUETOOTH® technologies, etc. More generally, any uni- or bi-directional communication technology known to one of ordinary skill in the art may be implemented in server device 200 to exchange information with e-commerce service provider device 104, customer devices 102(1)-102(n), or database 106 via communication network 108.

Processor 208 may include one or more known processing devices, such as a microprocessor from the Pentium™ or Xeon™ family manufactured by Intel™, or the Turion™ family manufactured by AMD™, for example. The disclosed embodiments are not limited to any type of processor(s) otherwise configured to meet the computing demands required of different components of system 100.

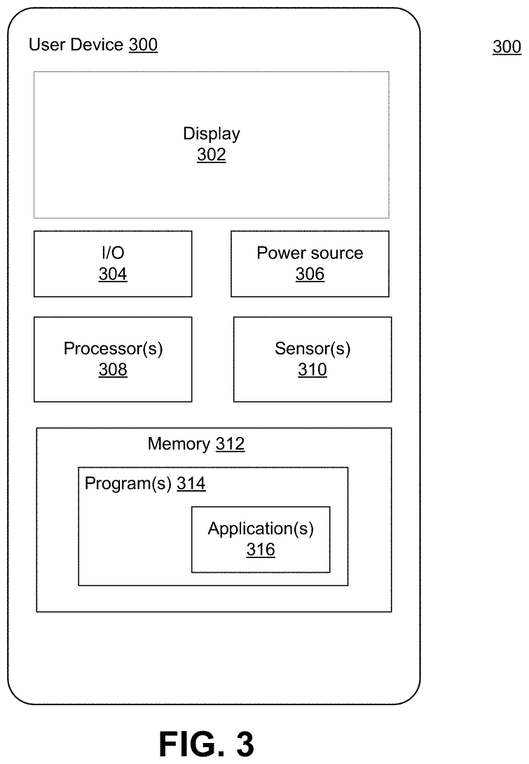

FIG. 3 shows an exemplary configuration of user device 300, consistent with disclosed embodiments. User device 300 of FIG. 3 represents an exemplary configuration of each of the customer devices 102(1)-102(n).

User device 300 may enable customers associated with customer devices 102(1)-102(n) to, for example, perform remote interactions or mobile transactions with e-commerce service provider device 104, or receive information from e-commerce service provider device 104. In some embodiments, user device 300 may be a personal computing device. For example, user device 300 may be a smartphone, a laptop or notebook computer, a tablet, a multifunctional watch, a pair of multifunctional glasses, or any mobile or wearable device with computing ability, or any combination of these computers and/or affiliated components. User device 300, in some embodiments, comprises a plurality of devices 302-316, including display device 302, I/O device 304, power source 306, one or more processors 308, one or more sensors 310, a memory 312. The memory 312 may include one or more programs 314, and the one or more programs 314 may include one or more applications 316. In some embodiments, each of the devices depicted in FIG. 3 may be present in singular form, while in other embodiments one or more of the devices may be consolidated, combined, or duplicated.

User device 300 includes display device 302. Display device 302 may include, for example, a liquid crystal display (LCD), a light emitting diode screen (LED), an organic light emitting diode screen (OLED), a touch screen, or other known display devices. Display device 302 may display various information to customers, drivers and merchants. For example, display device 302 may display an interactive interface enabling customers, drivers and merchants to operate user device 300 to perform certain aspects of the disclosed methods. Display device 302 may display touchable or selectable options for customers, drivers and merchants to select and may receive customer selection of options through a touch screen.

User device 300 includes I/O devices 304 that allows to send and receive information or interact with customers or another device. For example, I/O devices 304 may include various input/output devices, such as a keyboard, a mouse-type device, a gesture sensor, an action sensor, a physical button, switch, microphone, touchscreen panel, stylus, etc., that may be manipulated by customers to input information using user device 300. I/O devices 304 may also include an audio output device, such as a speaker configured to provide sound and audio feedback to customers operating user device 300. In some embodiments, I/O devices 304 may include a light emitting component, such as a LED or other component capable of providing a visible signal to customers, drivers and merchants. I/O devices 304 may also include haptic output devices, to provide haptic feedback to customers. I/O devices 304 may also include one or more communication modules (not shown) for sending and receiving information from other components in system 100 by, for example, establishing wired or wireless connectivity between user device 300 and communication network 108. I/O devices 304 may include radio frequency, infrared, or other near-field communication interfaces, for communicating with other devices associated with communication network 108. Exemplary communication modules of I/O devices 304 may include, for example, a short-range or near field wireless communication modem, a Wi-Fi™ communication modem, or a cellular communication modem. I/O devices 304 may include a transceiver or transmitter configured to communicate using one or more wireless technologies/protocols that may include, without limitation, cellular (e.g., 3G, 4G, etc.) technology, Wi-Fi™ hotspot technology, RFID, near-field communication (NFC) or BLUETOOTH® technologies, etc. More generally, any uni- or bi-directional communication technology known to one of ordinary skill in the art may be implemented in user device 300 to exchange information with e-commerce service provider device 104 or database 106 via communication network 108.

Power source 306 of user device 300 may be utilized to power user device 300 and the components therein. Power source 306 may be coupled to a battery (not shown in the drawings) that supplies power to turn on and off user device 300.

User device 300 includes one or more processors 308 configured to execute software instructions stored in memory, such as a memory 312. Processor(s) 308 may be, for example, a desktop CPU or a mobile CPU of known types.

User device 300 may include one or more sensors 310. Sensors 310 may include one or more gyroscope sensors, one or more cameras, one or more accelerometer sensors, although any other type of sensors may also be included in user device 300.

User device 300 may include memory 312 that may store one or more software programs 314 that when executed by processor 308 perform known Internet-related communication, content display processes, and other interactive processes for customers, drivers and/or merchants. For instance, user device 300 may execute a browser or related mobile display software that generates and displays interfaces including content on a display device 302 included in, or in communication with, user device 300. User device 300 may be a mobile device that executes mobile device applications and/or mobile device communication software, included in programs 314, that allows user device 300 to communicate with e-commerce service provider device 104 and other components via communication network 108, to generate and display content in interfaces via display device 302. The disclosed embodiments are not limited to any particular configuration of user device 300. User device 300 may include any arrangement of one or more computing devices configured to perform one or more operations consistent with disclosed embodiments.

User device 300 may be configured to store, in memory 312, one or more operating systems that perform known operating system functions when executed by processor 308. By way of example, the operating systems may include Microsoft Windows™, Unix™, Linux™, Android™, Apple™ Mac OS operating systems, iOS, Chrome OS, or other types of operating systems. Accordingly, disclosed embodiments may operate and function with computer systems running any type of operating system. User device 300 may also include communication software stored in memory 312 that, when executed by processor 308, provides communications with communication network 108, such as Web browser software, tablet or smart handheld device networking software, etc.

As described above, user device 300 may be a device that executes mobile applications for performing operations consistent with disclosed embodiments. Thus, in some embodiments, programs 314 stored on user device 300 may include one or more software applications 316 installed thereon, that enable user device 300 to communicate with e-commerce service provider device 104 via communication network 108 and perform aspects of the disclosed embodiments. For example, user device 300 may connect to e-commerce service provider device 104 by using browser software to access and receive information or perform other operations associated with an internet service provider.

According to an exemplary embodiment, software applications 316 associated with e-commerce service provider device 104 may be installed on user device 300, as shown in FIG. 3. For example, in an embodiment where customer devices 102(1)-102(n) may be implemented as user device 300. In this embodiment, e-commerce service provider device 104 may receive a request from user device 300 to download one or more software applications 316 to user device 300. In one embodiment, e-commerce service provider device 104 may receive the request from a customer associated with user device 300, using a web browser application native to user device 300 respectively. In another embodiment, e-commerce service provider device 104 may receive the request to download one or more software applications 316 associated with e-commerce service provider device 104 onto user device 300 from a webpage or another portal associated with e-commerce service provider device 104 accessed via user device 300. In this embodiment, e-commerce service provider device 104 may store software instructions corresponding to one or more software applications 316 in database 106. For responding to the download request, e-commerce service provider device 104 may receive additional information from user device 300 regarding the particular device specifications of user device 300 to enable user device 300 to download software instructions corresponding to the particular specifications. Alternatively, e-commerce service provider device 104 may push a download request link to user device 300 or transmit software code corresponding to one or more software applications 316 directly to user device 300 in, for example, an e-mail, a text or short message service (SMS) message, a prompt through an app, or other suitable method. User device 300 may receive the software code related to one or more software applications 316, such as via communication network 108, to download and install the software code.

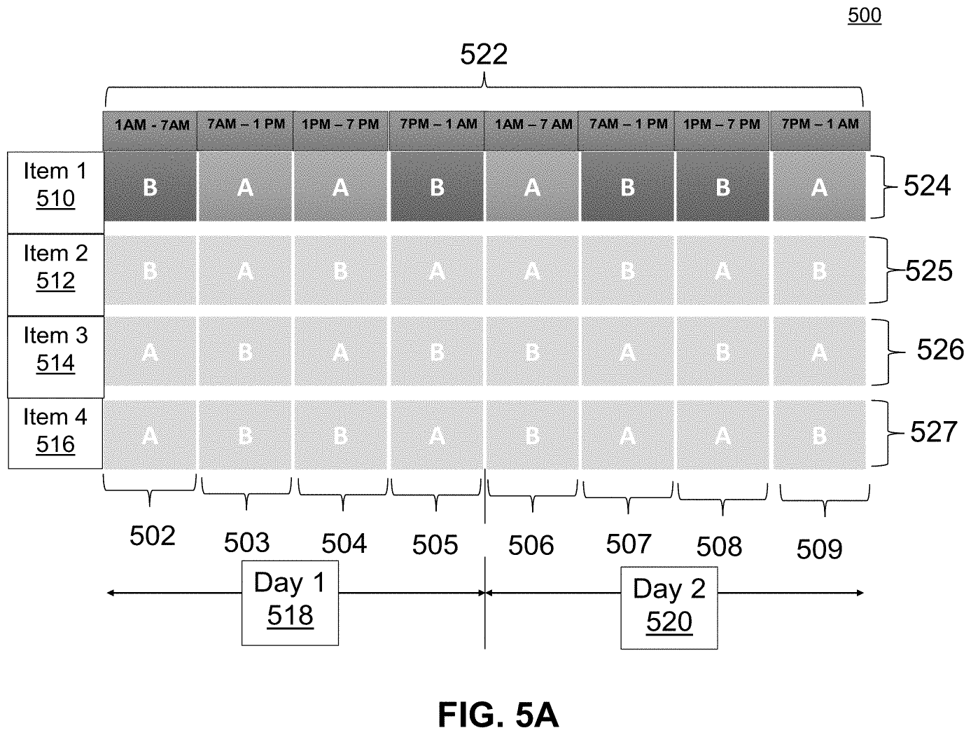

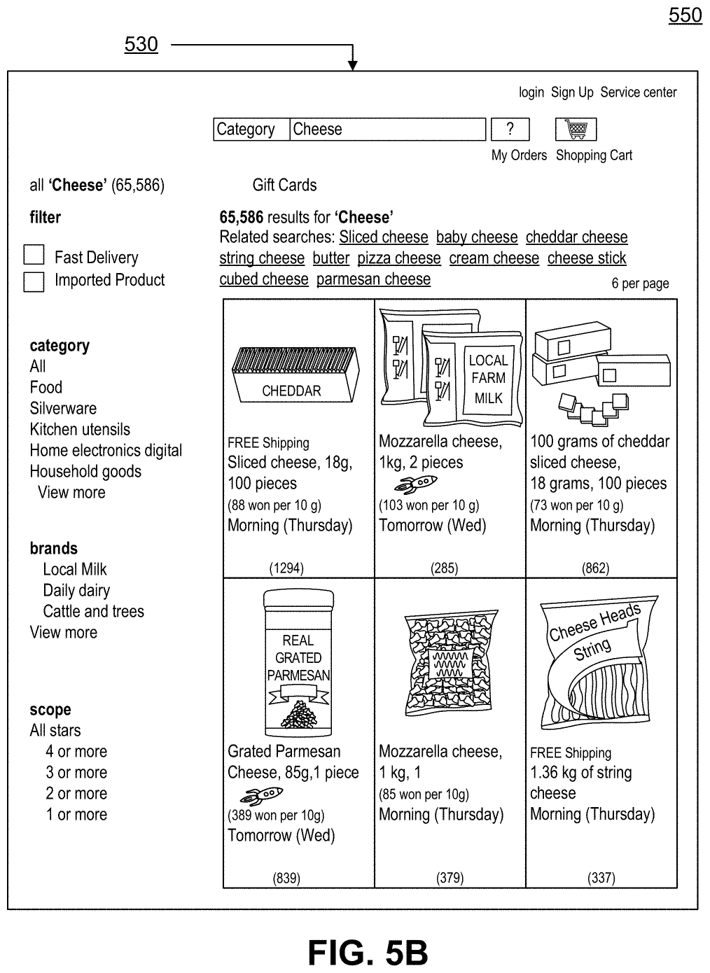

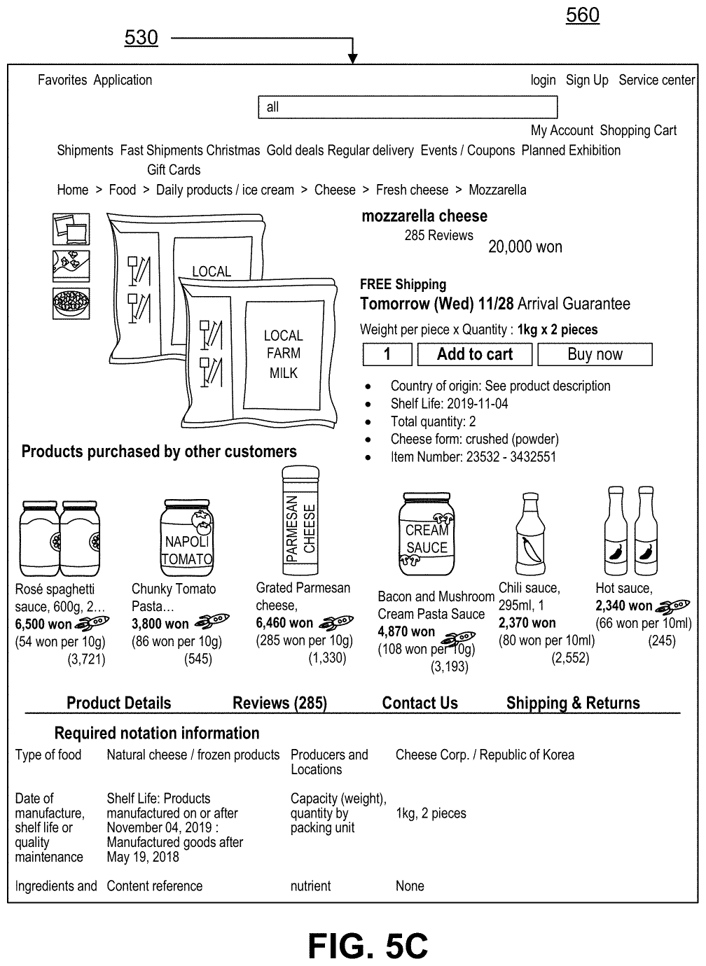

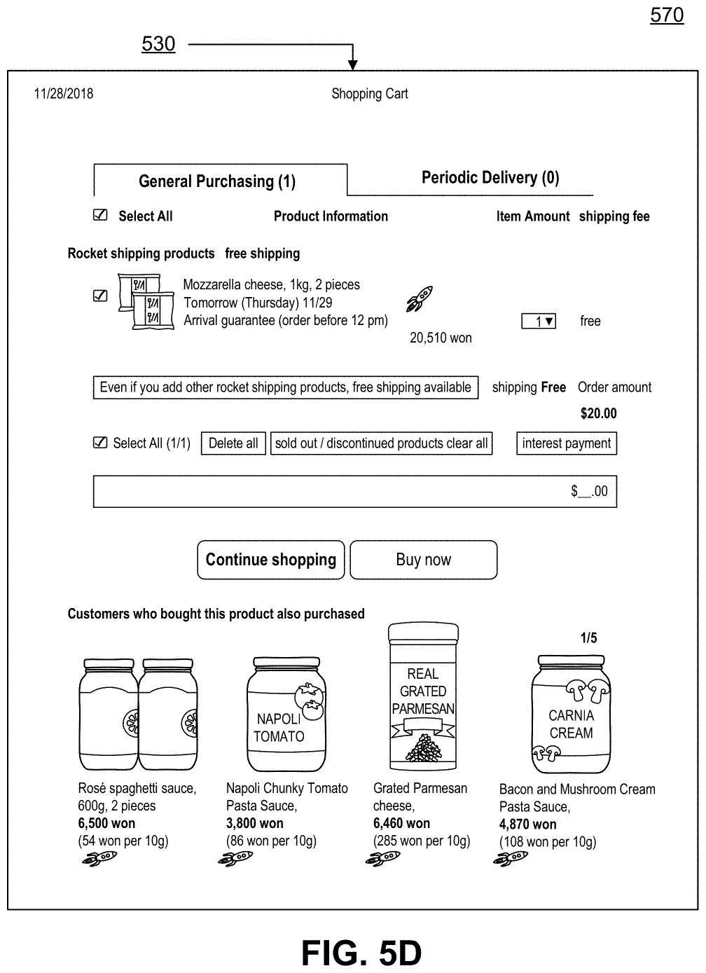

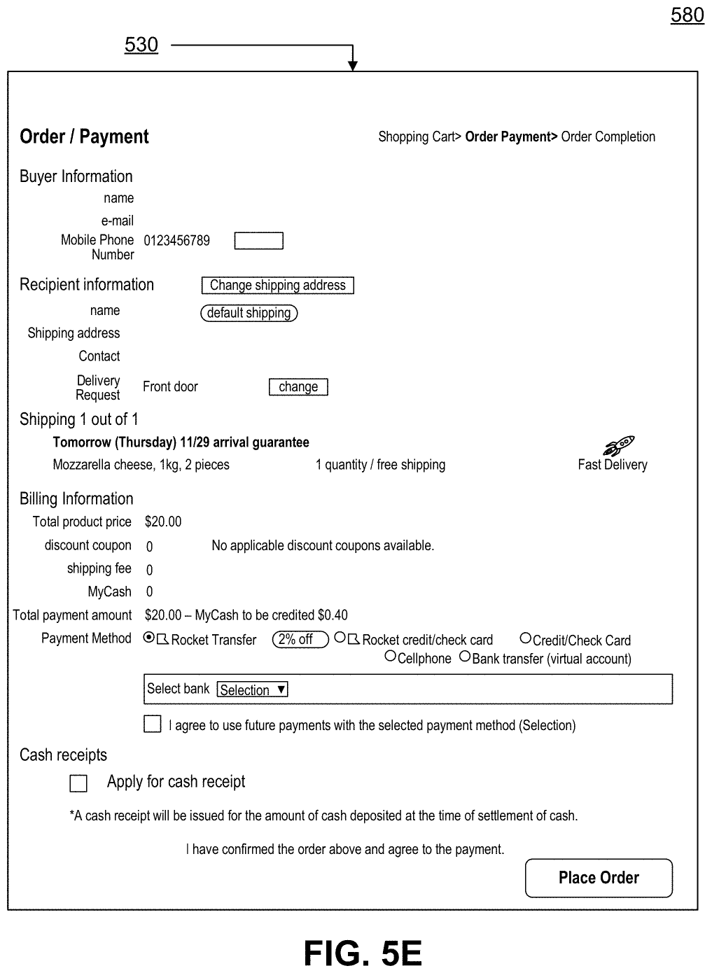

FIGS. 4A-4B contains a flowchart of an exemplary process 400 implemented by e-commerce service provider device 104 for experimentation of e-commerce pricing distribution based on time-interleaving, consistent with the disclosed embodiments. E-commerce service provider device 104 is implemented as a server device 200 of FIG. 2 to execute software instructions that perform one or more of the operations of process 400. Operations of process 400 are explained in association with FIG. 5A.

FIG. 5A contains a flow diagram 500 illustrating an exemplary process of FIGS. 4A and 4B. FIG. 5A illustrates an example pricing distribution table based on time-interleaving, implemented by e-commerce service provider device 104.

In accordance with process 400, in step 402, e-commerce service provider device 104 queries database 106 to access a pool of items stored in the database 106. By way of example, the pool of items may include hundreds of thousands of items available for customers to purchase, although any other number of items may also be included. The pool of items may include, for example, prepared food, groceries, electronics, furniture, books, computers, or clothes, although any other types of items available on an e-commerce website may also be included.

In step 404, e-commerce service provider device 104 identifies a first set of items. For example, e-commerce service provider device 104 identifies the first set of items from a pool of items based on pre-defined instructions. A web server module (not shown in drawings) included in e-commerce service provider device 104 may host an e-commerce website. The pre-defined instructions may be previously programmed by a system administrator and stored in memory 202. Pre-defined instructions may include, identifying items from a specific vendor, identifying items that are below a predefined price (e.g. items below $50, or items below $100, etc.), although any other type of pre-defined instruction may also be included. In another embodiment, e-commerce service provider device 104 identifies first set of items from pool of items based on a manual selection of items from the pool of items manually by a system administrator. By way of example, FIG. 5A shows a pricing distribution table 500 that illustrates identified first set of items that includes “Item 1” 510, “Item 2” 512, “Item 3” 514, and “Item 4” 516.

In another exemplary embodiment, “Item 1” 510, “Item 2” 512, “Item 3” 514, and “Item 4” 516 may each be a group of items. As explained above, items may include prepared food, groceries, electronics, furniture, books, computers, and/or clothes, although any other types of items available on an e-commerce website may also be included. Further, by way of example, each of “Item 1” 510, “Item 2” 512, “Item 3” 514, and “Item 4” 516 may include a group of items, such as books, groceries, computers, or clothing (among other things).

In another embodiment, by way of example, e-commerce service provider device 104 identifies a first set of items based on pricing policies stored in pricing policies storage 212 from a pool of items. By way of example, pricing policies may include, applying a 50% discount on the listed item price, providing free delivery by waiving shipping fees on items, identifying those items that can be sold at a 10% discount on the listed item price while maintaining a profit margin of 20%, identifying those items that can be shipped to customers with no shipping fees while maintaining a profit margin of 20%, identifying those items that can be shipped to customers at a 50% discount on shipping fees maintaining a profit margin of 20%, although any other type of item pricing related policies may also be included. This provides advantages of providing customers with items at discounted prices while still keeping a profit margin for the e-commerce websites. E-commerce service provider device 104 identifies those items from the pool of items that satisfy at least one of the pricing policies that are available to purchase on the e-commerce website for customers. Identified items that satisfy at least one of the pricing policies are determined be part of first set of items.

In another embodiment, e-commerce service provider device 104 identifies those items from the pool of items that satisfy at least two or more of the pricing policies that are available to purchase on the e-commerce website for customers, although any number of combinations of policies that may be satisfied may also be included.

In step 406, e-commerce service provider device 104 identifies a first time slot. In this step, e-commerce service provider device 104 determines a time slot from a plurality of time slots on which e-commerce service provider device 104 would perform pricing distribution based on time-interleaving. In this example, the plurality of time slots are time periods over a day during which items would be published on the e-commerce website hosted by e-commerce service provider device 104. By way of example, FIG. 5A shows a pricing distribution table 500 that illustrates a plurality of times slots 522. The plurality of time slots 522 over a spread of “Day 1” 518 and “Day 2” 520. “Day 1” 518 includes four time periods of a first time slot 502 of 1:00 AM-7:00 AM, a second time slot 503 of 7:00 AM-1:00 PM, a third time slot 504 of 1:00 PM-7:00 PM and a fourth time slot 505 of 7:00 PM-1:00 AM. Similarly, “Day 2” 520 includes four time periods of a first time slot 506 of 1:00 AM-7:00 AM, a second time slot 507 of 7:00 AM-1:00 PM, a third time slot 508 of 1:00 PM-7:00 PM and a fourth time slot 509 of 7:00 PM-1:00 AM. In another embodiment, any other time slot with different time periods and any number of time slots may be included as part of pricing distribution table 500.

A first set of items that are scheduled for a first time slot is scheduled to be published during that first time slot to e-commerce website and available for customers to purchase during that first time slot. Identifying a first time slot from plurality of time slots may be performed based on predefined instructions previously configured in the memory 202 of the e-commerce service provider device 104 that provides a predefined schedule to be followed. In this example, a predefined schedule includes an ordered sequence of time slots to be selected, such that all of the time slots 502-505 are utilized for scheduling first set of items 510, 512, 514 and 516 in a manner such that none of time slots are utilized more than once in a single day 518. Predefined instructions causes e-commerce service provider device 104 to select time slot 502 as first time slot and in another example, the predefined instructions cause e-commerce service provider device 104 to select time slot 505 as first time slot, although any time slot between 502-505 may be selected.

In another exemplary embodiment, identifying a first time slot from a plurality of time slots may be performed by applying a scheduling algorithm using pricing distribution module 214 stored in memory 202. Scheduling algorithm may include a random scheduling algorithm, although any other type of scheduling algorithm may also be included. Random scheduling algorithm stored in pricing distribution module 214 is an algorithm with pre-defined instructions. Pricing distribution module 214 applies random scheduling algorithm to perform a random selection of time slots from plurality of time slots at a time, in such an order that all of the time slots 502-505 are utilized for scheduling first set of items 510, 512, 514 and 516 in a manner such that none of time slots are utilized more than once in a single day 518. In this example, scheduling algorithm selects time slot 502 as first time slot.

In another example, scheduling algorithm may select time slot 505 as first time slot, although any time slot between 502-505 may be selected.

In step 408, e-commerce service provider device 104 identifies a first subset of substitutable items from the first set of items. First set of items includes may include, prepared food, beverages, carbonated drinks, snacks, groceries, electronics, furniture, books, computers, and/or clothes, although any other types of items may also be included. E-commerce service provider device 104 identifies those items from the pool of items that satisfy substitution rules stored in substitution rules storage 216 as first subset of substitutable items. Substitution rules stored in substitution rules storage 216 may include, by way of example, instructions configured to identify items that are to be the same category but from different brands or instructions configured to identify items that are to be in the same category but have opposite sales patterns based on previous sales history data, although other instructions may be configured to identify types of items that are can be substituted amongst each other.

In this example, with reference to FIG. 5A, e-commerce service provider device 104 identifies “Item 1” 510 and “Item 2” 512 as a first subset of substitutable items. By way of example, 510 and 512 are in the category of aerated drinks, and 510 is a Can of a first beverage company and 512 is a Bottle of a second beverage company. In this example, as first beverage company and second beverage company are both from the same category of aerated drinks but from different brands.

In another embodiment, with reference to FIG. 5A, e-commerce service provider device 104 identifies those items that are identified to be in the same category but have opposite sales patterns based on previous sales history data. Previous sales history data may include sales pattern of items within a particular time period. Time period may be 1 day, 1 week, 1 month or 1 year, although any other time period may also be included. Further, previous sales history may include, number of customers purchasing an item during a past time period. By way of example, e-commerce service provider device 104, analyzes the previous sales history data and may determine that an item such as a first chips company and a second chips company to be in the same category of snack food items, and may further determine that first chips company has an increasing sales pattern during the past month while the second chips company has a decreasing sales pattern during the past one month. Thus, e-commerce service provider device 104 determines that the first chips company and second chips company have opposite sales patterns and identifies “Item 1” 510 and “Item 2” 512 as a first subset of substitutable items.

In another exemplary embodiment, when “Item 1” 510, “Item 2” 512, “Item 3” 514, and “Item 4” 516 may each be a group of items (as explained above). In this example, e-commerce service provider device 104 identifies a first subset of substitutable items from the first set of items 510, 512, 514 and 516. By way of example, group of items included within each of “Item 1” 510, “Item 2” 512, “Item 3” 514, and “Item 4” 516, may include prepared food, beverages, carbonated drinks, snacks, groceries, electronics, furniture, books, computers, and/or clothes, although any other types of items may also be included. Thus, in step 408, e-commerce service provider device 104 identifies those items that are in the same category from the group of items included in “Item 1” 510 as a first subset of substitutable items. In this example, from the group of items in “Item 1” 510, those items identified to be in the same category of aerated drinks, for example, a can of a first beverage company and a bottle of a second beverage company may be included as a first subset of substitutable items. In this example, first beverage company and second beverage company are both from the same category of aerated drinks but from different brands. Similarly, e-commerce service provider device 104 identifies those items that are in the same category from the group of items included in “Item 2” 512, “Item 3” 514, and “Item 4” 516 as well.

In step 410, e-commerce service provider device 104 identifies a second subset of substitutable items from the first set of items. First set of items includes may include, prepared food, beverages, aerated drinks, groceries, electronics, furniture, books, computers, and/or clothes, although any other types of items may also be included. Second subset of substitutable items may include, by way of example, those items that are identified to be the same category but are from different brands, those items that are identified to have opposite sales patterns based on previous sales history data, although any other types of items that are can be substituted amongst each other may be included.

In this example, with reference to FIG. 5A, e-commerce service provider device 104 identifies “Item 3” 514 and “Item 4” 516 as a second subset of substitutable items. By way of example, e-commerce service provider device 104, analyzes the previous sales history data and determines that item 514 such as first furniture company and item 516 such as second furniture company are to be in the same category of furniture and further determines that item 514 has an increasing sales pattern during the past one month and item 516 has a decreasing sales pattern during the past one month. Thus, e-commerce service provider device 104 determines that the item 514 and item 516 have opposite sales patterns and thus identifies “Item 3” 514 and “Item 4” 516 as a second subset of substitutable items.

In another example, e-commerce service provider device 104 identifies “Item 3” 514 and “Item 4” 516 as a second subset of substitutable items. By way of example, e-commerce service provider device 104, analyzes the previous sales history data and determines that item 514, such as a first snack food item, and item 516, such as a second snack food item, are in the same category of snacks and further determines that item 514 has an increasing sales pattern during the past month and item 516 has a decreasing sales pattern during the past month. Thus, e-commerce service provider device 104 determines that the item 514 and item 516 have opposite sales patterns and thus identifies “Item 3” 514 and “Item 4” 516 as a second subset of substitutable items.

In yet another exemplary embodiment, when “Item 1” 510, “Item 2” 512, “Item 3” 514, and “Item 4” 516 may each be a group of items (as explained above). In this example, e-commerce service provider device 104 identifies a second subset of substitutable items from the first set of items 510, 512, 514 and 516. Thus, in step 408, e-commerce service provider device 104 identifies those items that are in the same category from the group of items included in “Item 1” 510 as a second subset of substitutable items. In this example, from the group of items in “Item 1” 510, those items identified to be in the same category of snacks, for example, a first snack food item and a second snack food item may be included as a second subset of substitutable items. In this example, first snack food item and second snack food item are both from the same category of snacks but from different brands. Similarly, e-commerce service provider device 104 identifies those items that are in the same category from the group of items included in “Item 2” 512, “Item 3” 514, and “Item 4” 516 as well.

In step 412, e-commerce service provider device 104 associates the first subset of substitutable items with a first pricing policy. In this step 412, e-commerce service provider device 104 applies a first pricing policy to first subset of substitutable items based on pre-defined instructions stored in memory 202. Pre-defined instructions may be previously programmed by a system administrator and stored in memory 202. Pre-defined instructions may include applying a first pricing policy to first subset of substitutable items identified in step 408.

By way of example, a first pricing policy may include associating and applying a 50% discount to the listed item price. In this example, with reference to FIG. 5A, in step 408 e-commerce service provider device 104 identifies “Item 1” 510 and “Item 2” 512 as a first subset of substitutable items. By way of example, item 510 is a Can of first beverage company with listed price of $1.99 and item 512 is a Bottle of second beverage company with a listed price of $2.99. Upon applying the first pricing policy of 50% discount to the listed item price, item 510 will have a listed price of $0.99 and item 512 will have a listed price of $1.49. In another embodiment, first pricing policy may be applied only to “Item 1” 510 and in another embodiment first pricing policy may be applied to “Item 2” 512. In yet another embodiment, any number of items in the first subset of substitutable items may be applied with first pricing policy.

First pricing policy may be stored in pricing policies storage 212 and may include, for example, applying a 10% discount on the listed item price, applying a 50% discount on the listed item price, providing free delivery by waiving shipping fees on items, identifying those items that can be sold at a 10% discount on the listed item price while maintaining a profit margin of 20%, identifying those items that can be shipped to customers with no shipping fees while maintaining a profit margin of 20%, identifying those items that can be shipped to customers at a 50% discount on shipping fees maintaining a profit margin of 20%, providing 10% discount on next purchase coupon to customers upon purchasing an item, providing $15 discount on purchase of an item, or providing $5 cashbacks to customers upon purchasing an item, although any other type of item pricing related policies may also be included.

In another embodiment, e-commerce service provider device 104 determines which one of the items from the first subset of substitutable items satisfy a first pricing policy from the plurality of pricing policies stored in pricing policies storage 212. Upon determining which one of the items satisfy the first pricing policy, e-commerce service provider device 104 associates and applies the first pricing policy to those items from the first subset of substitutable items that satisfy the first pricing policy.

In step 414, e-commerce service provider device 104 associates the second subset of substitutable items with a second pricing policy. In this step 414, e-commerce service provider device 104 applies a second pricing policy to second subset of substitutable items based on pre-defined instructions stored in memory 202. Pre-defined instructions may be previously programmed by a system administrator and stored in memory 202. Pre-defined instructions may include applying a second pricing policy to second subset of substitutable items identified in step 410.

By way of example, a second pricing policy may include associating and applying a 10% discount to the listed item price. In this example, with reference to FIG. 5A, in step 410 identifies “Item 3” 514 and “Item 4” 516 as a second subset of substitutable items. By way of example, item 514 is a first snack food item with listed price of $3.99 and item 516 is a second snack food item with a listed price of $4.99. Upon applying the second pricing policy of 10% discount to the listed item price, item 514 will have a listed price of $3.59 and item 516 will have a listed price of $4.49.

Second pricing policy may be stored in pricing policies storage 212 and may include, for example, applying a 10% discount on the listed item price, applying a 50% discount on the listed item price, providing free delivery by waiving shipping fees on items, identifying those items that can be sold at a 10% discount on the listed item price while maintaining a profit margin of 20%, identifying those items that can be shipped to customers with no shipping fees while maintaining a profit margin of 20%, identifying those items that can be shipped to customers at a 50% discount on shipping fees maintaining a profit margin of 20%, although any other type of item pricing related policies may also be included.

In another embodiment, e-commerce service provider device 104 determines which one of the items from the second subset of substitutable items satisfy second pricing policy of the plurality of policies stored in pricing policies storage 212. Upon determining which one of the items satisfy the second pricing policy, e-commerce service provider device 104 associates and applies the second pricing policy to those items from the second subset of substitutable items that satisfy second pricing policy.

Pricing policies storage 212 may store a plurality of pricing policies. Plurality of pricing policies may include, applying a 50% discount on the listed item price, providing free delivery by waiving shipping fees on items, identifying those items that can be sold at a 10% discount on the listed item price while maintaining a profit margin of 20%, identifying those items that can be shipped to customers with no shipping fees while maintaining a profit margin of 20%, identifying those items that can be shipped to customers at a 50% discount on shipping fees maintaining a profit margin of 20%, although any other type of item pricing related policies may also be included.

In step 416, e-commerce service provider device 104 publishes the first subset of substitutable items with the first pricing policy and the second subset of substitutable items with the second pricing policy 416. In this example, e-commerce service provider device 104 determines which time slot has been identified back in step 406 to schedule the publishing of the first set of items. In this example, with reference to FIG. 5A, e-commerce service provider device 104 determines that the first set of items 510, 512, 514 and 516 are to be published during the first time slot of 502 identified in step 404.

During the scheduled first time slot, e-commerce service provider device 104 publishes the first set of items 510, 512, 514 and 516, of which 510 and 512 are identified as a first subset of substitutable items and 514 and 516 are identified as second subset of substitutable items. E-commerce service provider device 104 publishes the first set of items 510, 512, 514 and 516 by displaying the first subset of substitutable items and the second subset of substitutable items with their discounted prices.

By way of example, e-commerce service provider device 104 publishes the first subset of substitutable items with list price that reflects the discounted price upon applying of the first pricing policy of 50% discount. As a result e-commerce service provider device 104 will publish item 510 on the e-commerce website with a listed price of $0.99 and item 512 with a listed price of $1.49.

By way of example, e-commerce service provider device 104 publishes the second subset of substitutable items with list price that reflects the discounted price upon applying of the second pricing policy of 10% discount. As a result, e-commerce service provider device 104 will publish item 514 on the e-commerce website with a listed price of $3.59 and item 516 with a listed price of $4.49.

In yet another exemplary embodiment, when “Item 1” 510, “Item 2” 512, “Item 3” 514, and “Item 4” 516 may each be a group of items (as explained above). The first subset of substitutable items identified in step 408 and second subset of substitutable items identified in step 410 from the group of items within “Item 1” 510, “Item 2” 512, “Item 3” 514, and “Item 4” 516 are published with their associated pricing policies determined with steps 412 and 414 respectively. Accordingly, a first pricing policy associated with the first set of substitutable items and a second pricing policy associated with the second set of substitutable items would be published during the time slot identified in step 404.

In step 418, e-commerce service provider device 104 monitors customer interaction with the published first subset of substitutable items and the published second subset of substitutable items during the published time slot. In this step 418, e-commerce service provider device 104 monitors the e-commerce website to track and stores in memory 202 customer interactions with the published first subset of substitutable items and second subset of substitutable items. Customer interactions may include, purchasing of the first subset of substitutable items and second subset of substitutable items, clicking of the first subset of substitutable items and second subset of substitutable items, or adding the first subset of substitutable items and second subset of substitutable items to a shopping cart, although any other interactions performed by a customer while shopping on an e-commerce website may also be stored in memory 202.

Before a predefined time period of the scheduled time slot ends, e-commerce service provider device 104 proceeds to step 420. Predefined time period may include 5 minutes after initiation of the time slot 502, 1 hour after initiation of the time slot 502, 1 hour before expiration of the time slot 502, 5 minutes before expiration of the time slot 502 or immediately after initiation of the time slot 502, although any number and/or combinations of time period may be included. While the method proceeds to step 420, e-commerce service provider device 104 continues monitoring and storing customer interactions with the published first subset of substitutable items and the published second subset of substitutable items until the published time slot ends.

In step 420, e-commerce service provider device 104 identifies if there are additional time slots that are not scheduled and are to be scheduled. E-commerce service provider device 104 identifies if there are other time slots during which the first set of items are to be scheduled for publishing, in such a manner that none of the time slots are utilized more that once during a single day. By way of example, with reference to FIG. 5A, e-commerce service provider device 104 determines if all of the time lots 502-505 in day 1 have been scheduled once. When e-commerce service provider device 104 determines that time slot 502 had been utilized to schedule the first set of items, and further determines that time slots 503-505 for day 1 are yet to be scheduled, then the method takes the Yes branch and loops back to step 406 and method proceeds to perform steps 406-420 until all of the time slots 502-505 have been scheduled once for day 1.

Back in step 420, when e-commerce service provider device 104 identifies if there are no other time slots during which the first set of items are to be scheduled for publishing. By way of example, with reference to FIG. 5A, e-commerce service provider device 104 determines that all of the time lots 502-505 in day 1 have been scheduled once, then e-commerce service provider device 104 determines that as all of the time slots for day 1 have been scheduled once, then the method proceeds to take the No branch to step 422.

In step 422, e-commerce service provider device 104 determines pricing distribution data based on the monitored customer interaction. Upon completion of monitoring of customer interaction data for all of the time slots 502-505, e-commerce service provider device 104 analyzes the customer interaction data stored in memory 202 to determine pricing distribution data. Pricing distribution data may include, a difference between actual sales amount of the first set of items during day 1 and an expected sales amount of the first set of items without applying of the pricing policies, a confidence value associated with each of the items in the first set of item, although any other data to be derived from analyzing customer interaction data may also be included. A confidence value that exceeds a threshold value indicates pricing policy applied to the item is favorable to be published permanently across the e-commerce website and a confidence value that does not exceed threshold value indicates pricing policy applied to the item is not favorable to be published permanently across the e-commerce website.

In another exemplary embodiment, upon identifying a first subset of substitutable items in step 408 and a second subset of substitutable items in step 410, e-commerce service provider device 104 may apply affinity rules (e.g., from affinity rules storage 218) to the first subset of substitutable items and second subset of substitutable items. Affinity rules may include, by way of example, associating a pricing policy to only one item from a set of items that have been identified to being purchased together or at the same time by customers, during a time slot. By way of example, a shaving razor item is identified as being purchased along with shaving gel by customers, in this situation, affinity rules causes that either the shaving razor or the shaving gel be applied with a pricing policy and not both during a time slot. Upon applying affinity rules stored in affinity rules storage 218, e-commerce service provider device 104 identifies, a set of items that have been identified to being purchased together or have been identified to being purchased at the same time, from first subset of substitutable items and second subset of substitutable items that have been identified in steps 408 and 410 respectively based on substitution rules stored in substitution rules storage 216. Upon identifying the set of items, method then proceeds to step 412, where e-commerce service provider device 104 would apply the first pricing policy only to one of the set of items that have been identified to being purchased together or at the same time from first subset of substitutable items. In step 414 e-commerce service provider device 104 would apply the second pricing policy only to one of the set of items that have been identified to being purchased together or at the same time from second subset of substitutable items, and the method proceeds to step 416, to perform operations from step 416 (as explained above).

In another embodiment, e-commerce service provider device 104 determines analyzes the pricing distribution data to determine if a confidence value exceeds a threshold value. Threshold value may be pre-defined by a system administrator and stored in memory 202. Upon determining that the confidence value does exceed a threshold value, then e-commerce service provider device 104 publishes the item with the associated pricing policy permanently across the e-commerce website without the constraint of the time slots. Further, upon determining that the confidence value does not exceed threshold value, then e-commerce service provider device 104 does not publish the item with the associated pricing policy permanently across the e-commerce website and the method ends here.

By way of example, e-commerce service provider device 104 determines that item 501 has a confidence value of 60% based on analyzing customer interaction data. Further, threshold value is pre-defined to be 40%. In this example, as e-commerce service provider device 104 determines that item 501 has confidence value of 60% that exceeds the threshold value of 40% then e-commerce service provider device 104 publishes the item with the associated pricing policy permanently across the e-commerce website without the constraint of the time slots. In another embodiment, the pricing distribution data may be monitored by system administrators manually to perform any further actions.

An illustrative set of steps, illustrated by FIGS. 5B, 5C, 5D, and 5E, will help to describe some operations of e-commerce service provider device 104 publishing items on e-commerce website. In this embodiment, user device 300 is implemented as customer devices 102(1)-102(n). User device 300 may receive information from e-commerce service provider device 104 for presentation and/or display. For example, e-commerce service provider device 104 may host or provide one or more web pages, including a Search Result Page (SRP) 550 (e.g., FIG. 5B), a Single Detail Page (SDP) 560 (e.g., FIG. 5C), a Cart page 570 (e.g., FIG. 5D), or an Order page 580 (e.g., FIG. 5E). A user device 300 (e.g., customer devices 102(1)-102(n)) may navigate to e-commerce website 530 hosted by e-commerce service provider device 104 and request a search by entering information into a search box. User device 300 may request information from one or more systems in system 100. For example, user device 300 may request information from e-commerce service provider device 104 that satisfies the search request. User device 300 may also request and receive (from e-commerce service provider device 104) a Promised Delivery Date or “PDD” for each item included in the search results. The PDD, in some embodiments, may represent an estimate of when a package containing the item will arrive at the user's desired location or a date by which the item is promised to be delivered at the user's desired location if ordered within a particular period of time, for example, by the end of the day (11:59 PM).

E-commerce service provider device 104 may prepare an SRP 550 (e.g., FIG. 5B) based on the information. The SRP 550 may include information that satisfies the search request. For example, this may include pictures of items that satisfy the search request. The SRP 550 may also include respective prices for each item, or information relating to enhanced delivery options for each item, PDD, weight, size, offers, discounts, or the like. E-commerce service provider device 104 may send the SRP 550 to the requesting user device 300 (e.g., via communication network 108) as part of publishing the items to e-commerce website 530. Items displayed on e-commerce website 530 are displayed upon publishing of items by e-commerce website provider 104.

User device 300 may then select an item from the SRP 550, e.g., by clicking or tapping a user interface, or using another input device, to select an item represented on the SRP 550. The user device 300 may formulate a request for information on the selected item and send it to e-commerce service provider device 104. In response, e-commerce service provider device 104 may request information related to the selected item. For example, the information may include additional information beyond that presented for an item on the respective SRP 550. This could include, for example, price, shelf life, country of origin, weight, size, number of items in package, handling instructions, or other information about the item. The information could also include recommendations for similar items (based on, for example, big data and/or machine learning analysis of customers who bought this item and at least one other item), answers to frequently asked questions, reviews from customers, manufacturer information, pictures, or the like.

E-commerce service provider device 104 may prepare an SDP 560 (Single Detail Page) (e.g., FIG. 5C) based on the received item information. The SDP 560 may also include other interactive elements such as a “Buy Now” button, a “Add to Cart” button, a quantity field, a picture of the item, or the like. The SDP 560 may further include a list of sellers that offer the item. The list may be ordered based on the price each seller offers such that the seller that offers to sell the item at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. E-commerce service provider device 104 may deliver the SDP 560 to the requesting user device 300 (e.g., via communication network 108).

The requesting user device 300 may receive the SDP 560 which lists the item information. Upon receiving the SDP 560, the user device may then interact with the SDP 560. For example, a user of the requesting user device 300 may click or otherwise interact with a “Place in Cart” button on the SDP 560. This adds the item to a shopping cart associated with the user. The user device 300 may transmit this request to add the item to the shopping cart e-commerce service provider device 104.

E-commerce service provider device 104 may generate a Cart page 570 (e.g., FIG. 5D). The Cart page 570, in some embodiments, lists the items that the user has added to a virtual “shopping cart.” A user device 300 may request the Cart page 570 by clicking on or otherwise interacting with an icon on the SRP 550, SDP 560, or other pages. The Cart page 570 may, in some embodiments, list all items that the user has added to the shopping cart, as well as information about the items in the cart such as a quantity of each item, a price for each item per item, a price for each item based on an associated quantity, information regarding PDD, a delivery method, a shipping cost, user interface elements for modifying the items in the shopping cart (e.g., deletion or modification of a quantity), options for ordering other item or setting up periodic delivery of items, options for setting up interest payments, user interface elements for proceeding to purchase, or the like. A user at a user device 300 may click on or otherwise interact with a user interface element (e.g., a button that reads “Buy Now”) to initiate the purchase of the item in the shopping cart. Upon doing so, the user device 300 may transmit this request to initiate the purchase to e-commerce service provider device 104.

E-commerce service provider device 104 may generate an Order page 580 (e.g., FIG. 5E) in response to receiving the request to initiate a purchase. The Order page 580, in some embodiments, re-lists the items from the shopping cart and requests input of payment and shipping information. For example, the Order page 580 may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. E-commerce service provider device 104 may send the Order page 580 to the user device 300.

The user device 300 may enter information on the Order page 580 and click or otherwise interact with a user interface element that sends the information to e-commerce service provider device 104. From there, e-commerce service provider device 104 may send the information to different systems in system 100 to enable the creation and processing of a new order with the items in the shopping cart.

In some embodiments, e-commerce service provider device 104 may be further configured to enable sellers to transmit and receive information relating to orders.

The disclosed embodiments provide an improved method of e-commerce pricing distribution based on time-interleaving. By providing technical advantages of an optimized process of testing price changes of substitutable items on e-commerce websites while retaining customer trust. As this technology provides a system to schedule publishing of item on websites during an identified time slot and monitoring customer interaction with the published substitutable items, this technology provides a fast and reliable process of testing price changes, which results in optimizing pricing distribution and improving customer experience. Further, as this technology monitors customer interactions with the substitutable items, this technology provides an optimized process of determining customer responses and item price change effects on customer purchase activity that would be used in improving an e-commerce businesses goals and also improve customer experience.

In contrast, in the prior art, other strategies that have been implemented are inefficient as they do not take into consideration utilization of substitutable items, which may not be beneficial to customers and results in poor customer experience. Further the prior art causes loss of customer trust, while the disclosed embodiments provides an e-commerce pricing method, that improves customer experience.

While illustrative embodiments have been described herein, the scope thereof includes any and all embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified. Thus, the foregoing description has been presented for purposes of illustration only. It is not exhaustive and is not limiting to the precise forms or embodiments disclosed. Modifications and adaptations will be apparent to those skilled in the art from consideration of the specification and practice of the disclosed embodiments.

The elements in the claims are to be interpreted broadly based on the language employed in the claims and not limited to examples described in the present specification or during the prosecution of the application, which examples are to be construed as non-exclusive. It is intended, therefore, that the specification and examples be considered as exemplary only, with a true scope and spirit being indicated by the following claims and their full scope of equivalents.

1. A computer-implemented system for experimentation of e-commerce pricing distribution based on time-interleaving, the system comprising:
a memory storing instructions; and
at least one processor configured to execute the instructions to:
identify a first set of items from a plurality of items based on one or more item pricing policies;
identify a first time slot from a plurality of time slots for publishing the first set of items on a website based on predefined instructions, publishing the first set of items during the first time slot further comprising:
identify a first subset of substitutable items and a second subset of substitutable items from the first set of items based on one or more item substitution rules;
assign the first subset of substitutable items with a first pricing policy and the second subset of substitutable items with a second pricing policy; and
publish the first subset of substitutable items assigned with the first pricing policy over the first time slot on the website and publish the second subset of substitutable items assigned with the second pricing policy over the first time slot on the website;
determine pricing distribution data based on monitoring customer interaction with the published first subset of substitutable items and the published second subset of substitutable items, the pricing distribution data comprising a confidence value associated with at least one item of the first set of items,
wherein the monitored customer interaction comprises at least one of:
receiving an indication to purchase any of the first subset of substitutable items and second subset of substitutable items on the website,
clicking on any of the first subset of substitutable items or second subset of substitutable items on the website, or
adding any of the first subset of substitutable items and second subset of substitutable items to a shopping cart associated with the website;
determine the confidence value exceeds a predefined threshold; and
publish the at least one item with the associated first or second pricing policy on the website permanently.

2. The system of claim 1, wherein the instructions further cause the processor to:
identify a second time slot from the plurality of time slots for publishing the first set of items on the website based on the predefined instructions, publishing the first set of items during the second time slot, further comprising:
identify a third subset of substitutable items and a fourth subset of substitutable items from the second set of items based on the one or more item substitutions rules;
assign the third subset of substitutable items with the first pricing policy and the fourth subset of substitutable items with the second pricing policy;
publish the third subset of substitutable items assigned with the first pricing policy over the second time slot on the website and publish the fourth subset of substitutable items assigned with the second pricing policy over the second time slot on the website; and
determine pricing distribution data based on monitoring customer interaction with the published third subset of substitutable items and the published fourth subset of substitutable items.

3. The system of claim 1, wherein the one or more item substitution rules comprise at least one of two or more items from the first set of items that are identified to be of a same category but from different brands or two or more items from the first set of items that are identified to be in the same category but have opposite sales patterns based on stored sales history data.

4. (canceled)

5. The system of claim 1, wherein the pricing distribution data comprise at least one of a difference between actual sales amount of at least one item from the first set of items during the first time slot and an expected sales amount of the at least one item without applying the respective first or second pricing policies or a confidence value associated with the at least one item of the first set of items.

6. (canceled)

7. The system of claim 1, wherein the instructions further cause the processor to:
display the first subset of substitutable items with the first pricing policy and display the second subset of substitutable items with the second pricing policy on the website, upon publishing of the first subset of substitutable items and the second subset of substitutable items,
wherein the first pricing policy comprises one or more of applying a discount on the listed item price of at least one of the first subset of substitutable items, providing coupons to customers upon purchasing of one of the first subset of substitutable items, or providing cashbacks to customers upon purchasing of one of the first subset of substitutable items or the second subset of substitutable items.

8. A computer implemented method for experimentation of e-commerce pricing distribution based on time-interleaving, the method comprising:
identifying a first set of items from a plurality of items based on one or more item pricing policies;
identifying a first time slot from a plurality of time slots for publishing the first set of items on a website based on predefined instructions, publishing the first set of items during the first time slot further comprising:
identifying a first subset of substitutable items and a second subset of substitutable items from the first set of items based on one or more item substitution rules;
assigning the first subset of substitutable items with a first pricing policy and the second subset of substitutable items with a second pricing policy; and
publishing the first subset of substitutable items assigned with the first pricing policy over the first time slot on the website and publishing the second subset of substitutable items assigned with the second pricing policy over the first time slot on the website;
determining pricing distribution data based on monitoring customer interaction with the published first subset of substitutable items and the published second subset of substitutable items, the pricing distribution data comprising a confidence value associated with at least one item of the first set of items,
wherein the monitored customer interaction comprises at least one of:
receiving an indication to purchase any of the first subset of substitutable items and second subset of substitutable items on the website,
clicking on any of the first subset of substitutable items or second subset of substitutable items on the website, or
adding any of the first subset of substitutable items and second subset of substitutable items to a shopping cart associated with the website;
determine the confidence value exceeds a predefined threshold; and
publish the at least one item with the associated first or second pricing policy on the website permanently.

9. The method of claim 8, further comprising:
identifying a second time slot from the plurality of time slots for publishing the first set of items on the website based on the predefined instructions, publishing the first set of items during the second time slot, further comprising:
identifying a third subset of substitutable items and a fourth subset of substitutable items from the second set of items based on the one or more item substitutions rules;
assigning the third subset of substitutable items with the first pricing policy and the fourth subset of substitutable items with the second pricing policy;
publishing the third subset of substitutable items assigned with the first pricing policy over the second time slot on the website and publishing the fourth subset of substitutable items assigned with the second pricing policy over the second time slot on the website; and
determining pricing distribution data based on monitoring customer interaction with the published third subset of substitutable items and the published fourth subset of substitutable items.

10. The method of claim 8, wherein the one or more item substitution rules comprise at least one of two or more items from the first set of items that are identified to be of a same category but from different brands or two or more items from the first set of items that are identified to be in the same category but have opposite sales patterns based on stored sales history data.

11. (canceled)

12. The method of claim 8, wherein the pricing distribution data comprise at least one of a difference between actual sales amount of at least one item from the first set of items during the first time slot and an expected sales amount of the at least one item without applying the respective first or second pricing policies or a confidence value associated with the at least one item of the first set of items.

13. (canceled)

14. The method of claim 8, further comprising:
displaying the first subset of substitutable items with the first pricing policy and display the second subset of substitutable items with the second pricing policy on the website, upon publishing of the first subset of substitutable items and the second subset of substitutable items,
wherein the first pricing policy comprises one or more of applying a discount on the listed item price of at least one of the first subset of substitutable items, providing coupons to customers upon purchasing of one of the first subset of substitutable items, or providing cashbacks to customers upon purchasing of one of the first subset of substitutable items or the second subset of substitutable items.

15. A computer-implemented system for experimentation of e-commerce pricing distribution based on time-interleaving, the system comprising:
a memory storing instructions; and
at least one processor configured to execute the instructions to:
identify a first set of items from a plurality of items based on one or more item pricing policies;
identify a first time slot from a plurality of time slots for publishing the first set of items on a website based on predefined instructions, publishing the first set of items during the first time slot further comprising:
identify a first subset of substitutable items and a second subset of substitutable items from the first set of items based on one or more item substitution rules;
assign the first subset of substitutable items with a first pricing policy and the second subset of substitutable items with a second pricing policy; and
publish the first subset of substitutable items assigned with the first pricing policy over the first time slot on the website and publish the second subset of substitutable items assigned with the second pricing policy over the first time slot on the website;
determine pricing distribution data based on monitoring customer interaction with the published first subset of substitutable items and the published second subset of substitutable items, the pricing distribution data comprising a difference between actual sales amount of at least one item from the first set of items during the first time slot and an expected sales amount of the at least one item without applying the respective first or second pricing policies and a confidence value associated with the at least one item of the first set of items,
wherein the monitored customer interaction comprises at least one of:
receiving an indication to purchase any of the first subset of substitutable items and second subset of substitutable items on the website,
clicking on any of the first subset of substitutable items or second subset of substitutable items on the website, or
adding any of the first subset of substitutable items and second subset of substitutable items to a shopping cart associated with the website;
determine the confidence value exceeds a predefined threshold; and
publish the at least one item with the associated first or second pricing policy on the website permanently.

16. The computer-implemented system of claim 15, wherein
the instructions further cause the processor to:
identify a second time slot from the plurality of time slots for publishing the first set of items on the website based on the predefined instructions, publishing the first set of items during the second time slot, further comprising:
identify a third subset of substitutable items and a fourth subset of substitutable items from the second set of items based on the one or more item substitutions rules;
assign the third subset of substitutable items with the first pricing policy and the fourth subset of substitutable items with the second pricing policy;
publish the third subset of substitutable items assigned with the first pricing policy over the second time slot on the website and publish the fourth subset of substitutable items assigned with the second pricing policy over the second time slot on the website; and
determine pricing distribution data based on monitoring customer interaction with the published third subset of substitutable items and the published fourth subset of substitutable items.

17. The computer-implemented system of claim 15, wherein the one or more item substitution rules comprise at least one of two or more items from the first set of items that are identified to be of a same category but from different brands or two or more items from the first set of items that are identified to be in the same category but have opposite sales patterns based on stored sales history data.

18. (canceled)

19. The computer-implemented system of claim 15, wherein the pricing distribution data comprise at least one of a difference between actual sales amount of at least one item from the first set of items during the first time slot and an expected sales amount of the at least one item without applying the respective first or second pricing policies or a confidence value associated with the at least one item of the first set of items.

20. (canceled)

21. The computer-implemented system of claim 15, wherein
the instructions further cause the processor to:
display the first subset of substitutable items with the first pricing policy and display the second subset of substitutable items with the second pricing policy on the website, upon publishing of the first subset of substitutable items and the second subset of substitutable items,
wherein the first pricing policy comprises one or more of applying a discount on the listed item price of at least one of the first subset of substitutable items, providing coupons to customers upon purchasing of one of the first subset of substitutable items, or providing cashbacks to customers upon purchasing of one of the first subset of substitutable items or the second subset of substitutable items.

22. The computer-implemented system of claim 1, wherein assigning the first subset of substitutable items with a first pricing policy and the second subset of substitutable items with a second pricing policy comprises:
applying affinity rules to the first subset of substitutable items and to the second subset of substitutable items;
identifying a batch of items from the first set of items that are regularly purchased together based on stored sales history data;
applying one of the first pricing policy and the second pricing policy to one item of the batch of items.

23. The method of claim 8, wherein assigning the first subset of substitutable items with a first pricing policy and the second subset of substitutable items with a second pricing policy comprises:
applying affinity rules to the first subset of substitutable items and to the second subset of substitutable items;
identifying a batch of items from the first set of items that are regularly purchased together based on stored sales history data;
applying one of the first pricing policy and the second pricing policy to one item of the batch of items.

24. The computer-implemented system of claim 15, wherein assigning the first subset of substitutable items with a first pricing policy and the second subset of substitutable items with a second pricing policy comprises:
applying affinity rules to the first subset of substitutable items and to the second subset of substitutable items;
identifying a batch of items from the first set of items that are regularly purchased together based on stored sales history data;
applying one of the first pricing policy and the second pricing policy to one item of the batch of items.
